(19) United States
(12) Patent Application Publication
(10) Pub. No.: US 2025/0290309 A1
(43) Pub. Date: Sep. 18, 2025

(54) METHOD FOR MANUFACTURING A THREE-DIMENSIONAL STRUCTURE THAT CAN BE DEPLOYED FROM AN ALIGNABLE MESH, AND THREE-DIMENSIONAL STRUCTURE OBTAINED VIA SUCH A METHOD

(71) Applicant: CANOPEE STRUCTURES, Champs Sur Marne (FR)

(72) Inventor: Xavier TELLIER, Champs Sur Marne (FR)

(21) Appl. No.: 18/263,219

(22) PCT Filed: Jan. 28, 2022
(86) PCT No.: PCT/EP2022/051985

§ 371 Date: Jul. 5, 2024

(30) Foreign Application Priority Data
Jan. 30, 2021 (EP) 21315015.4

(51) Int. Cl. E04B 1/35; E04B 1/19; E04B 1/32

(52) U.S. Cl. CPC E04B 1/35; E04B 1/19; E04B 1/32; E04B 2001/1984; E04B 2001/3235

(57) ABSTRACT

The invention relates to a method for manufacturing a three-dimensional structure (2) that can be deployed in a compact first configuration and at least one deployed second configuration, the method of manufacture comprising: —a first step, performed by a computer, of generating a so-called alignable mesh (14) from an initial discretized quadrangle mesh; the alignable mesh (14) being obtained by deforming the quadrangles of the initial mesh; a mesh being said to be alignable if such a mesh can be deformed into a rectilinear configuration by angularly modifying the mesh at its nodes and by keeping the side lengths constant; —a second step of manufacturing the three-dimensional structure (2) in its compact first configuration, the three-dimensional structure (2) being manufactured from said generated alignable mesh (14) and having, in its compact first configuration, in the form of an almost-linear preform, the form of a bundle, said preform comprising elastically deformable beams (11), the nodes of the alignable mesh (14) defining positions for connectors that join together the beams (11) of the preform.

### TECHNICAL FIELD

The present invention relates to a method for manufacturing a deployable three-dimensional structure. Such a deployable three-dimensional structure is typically embodied by means of a mesh of beams, such beams being able for example to be like rings, tubes with round or rectangular cross sections, bars with rectangular cross-sections, profiled elements with C-shaped cross sections, or angles, or composed of several of these elements mechanically secured to one another, thus forming a composite beam. More specifically, such a mesh of elastic beams is of the “elastic gridshell” type. The present invention also relates to a computer program product comprising instructions for executing at least one of the steps of such a manufacturing method, as well as a deployable three-dimensional structure manufactured via such a method.

Many industrial applications of the present invention, as well as numerous technical fields of application, have been identified, including, without this list being exhaustive, the fields of construction, street furniture or urban architecture, space, defense, underwater vehicles or even events or shows and entertainment.

### STATE OF THE ART

The concept of “elastic gridshell” is developed in patent document FR 3 080 390 A1. Such a “gridshell” may be defined as a discrete shell that is obtained by elastic deformation of a continuous bidirectional grid, planar or not, without shear stiffness and then stiffened by bars, cables or diaphragms in a third spatial direction. Thus defined, a gridshell has an interesting structural potential and is able to meet complex architectural requirements.

Elastic gridshells thus constitute an economic means for designing lightened three-dimensional structures. Such three-dimensional structures are deployable between a compact first configuration and at least one deployed second configuration. Conventionally, during the gridshell assembly method, a bidirectional grid of deformable beams is assembled on the floor, connected together by connecting means allowing a variation in the angles formed between these beams, without sliding. The grid is then raised to reach its desired final shape, using elastic deformations on the beams, and by acting concomitantly on angular rotations at the connection means between the beams (in fact, during such elastic deformations the angles formed between the beams vary). When it is desired to retain the obtained three-dimensional shape, it is then necessary to brace the network by attaching, for example, additional straps, spacers or cables on the beams forming the mesh, the effect of which is to fix certain quadrangles of the mesh in their deformed configuration. Such three-dimensional structures are then made of a flexible material, but offer a certain rigidity that is obtained through their shape.

The flexible material forming the deformable beams may for example be a composite, such as a composite with a polymer matrix containing glass fibers, manufactured for example by pultrusion, or a wood or metal material.

Elastic gridshells are conventionally divided into two families: gridshells with regular grids and gridshells with irregular grids.

In gridshells with regular grids, the distance between the connection nodes of the mesh is constant. More precisely, on each given beam, the distance between the adjacent connections of the beam is constant. In other words, the mesh has a constant side length. This guarantees that the structure can be assembled on the floor in a configuration without constraints. However, a disadvantage that this type of regular grid structure poses is that it imposes a strong design constraint on the modeling.

Having a constant side length is not, however, sufficient for a mesh to be able to describe a gridshell: the internal forces within the structure represented by this mesh must in fact be in equilibrium. To this end, a step consisting in releasing constraints on the geometry can be carried out. However, another mechanical constraint is that the curvature of the beams is limited by the elasticity of the material. The underlying problem consists in evaluating how the grid is spread over a corresponding three-dimensional mathematical surface. The search for an optimal grid orientation was for example carried out in research work by Lina Bouhaya et al. (“Optimization of gridshell bar orientation using a simplified genetic approach”—2014). On certain surfaces, the constraint consisting in simultaneously having a regular grid and a small beam curvature can result in an over-constraint problem. This has led to research on gridshells with irregular grids (in other words, with non-constant side lengths in the mesh).

For example, in the work of Lafuente Hernandez et al. (“Topology optimisation of regular and irregular elastic gridshells by means of a non-linear variational method”—2012; and “On the Design and Construction of Elastic Gridshells with Irregular Meshes”—2013), the authors propose to treat the constant side length as a soft constraint in an optimization loop, which also minimizes the curvature of the beams and the proximity to a target surface. The system can then be brought into an almost-planar configuration, but the beams must be held forcibly in place in order to be assembled in a grid.

Irregular grid structures offer tremendous freedom of design. However, a current limitation of such irregular grid structures is their design process. Indeed, the ability to guarantee that the shapes obtained by these irregular grids are in a state wherein the grids are easy to assemble has hitherto been provided by complex digital tools that are far from being intuitive for users. Most of the methods known up to now, which use irregular grids for the design of the gridshell, thus implement a complete modeling and simulation of the deployment movement thereof. This involves complex and time-consuming calculations by the computer whereupon the prior design step of the structure is carried out.

There is therefore a need to be able to have deployable three-dimensional structures based on irregular grids, which have a high structural strength while being compact and easy to deploy and transport, and the design method of which is simple and reduces the computing resources consumed.

### SUMMARY OF THE INVENTION

An object of the present invention is to at least partially mitigate the above-mentioned disadvantages.

In particular, a first objective of the present invention is to provide a method for manufacturing a deployable three-dimensional structure that allows a compact three-dimensional structure to be obtained simply which has a high structural strength combined with ease of deployment and transport.

A second objective is to propose a method for manufacturing a deployable three-dimensional structure which, using an irregular grid, allows any new geometric shapes for the structure to be achieved, thus resulting in a wide variety of possible shapes.

A third objective is to propose a method for manufacturing such a deployable three-dimensional structure that allows a reduction of computing resources consumed during the design step of the structure.

To this end, the invention relates to a method for manufacturing a three-dimensional structure, said three-dimensional structure being deployable in a compact first configuration and at least one deployed second configuration, the method of manufacture comprising:
a first step, implemented by computer, of generating a mesh, the mesh comprising a plurality of discretized quadrangles, and a predetermined number of nodes connected to one another by oriented sides, a predetermined orientation being assigned to each side among two possible orientations, each elementary quadrangle of the mesh having a first pair of opposite sides oriented according to a first orientation, and a second pair of opposite sides oriented according to a second orientation, distinct from the first orientation;
a second step of manufacturing the three-dimensional structure, the three-dimensional structure being manufactured from the mesh generated at the end of the first step; the three-dimensional structure being in its compact first configuration in the form of a preform, said preform comprising elastically deformable beams.

According to the invention, the mesh generated during the first step is a so-called alignable mesh, a discretized quadrangle mesh being said to be alignable if such a mesh can be deformed into a rectilinear configuration by angularly modifying the mesh at its nodes and keeping the side lengths constant, or if, for any oriented path traveled along a closed loop and composed of oriented path segments {e₁, . . . , eₙ}, where each segment coincides with a side of the mesh, the following equation is verified for this path:

$${Σ}_{i = 1}^{n} {ε}_{i} ‖ {e}_{i} ‖ = 0 ; \qquad ( 1 )$$

with: εᵢ=+1 if the segment eᵢ has the same orientation as the coincident side of the mesh, and εᵢ=−1 otherwise; ∥eᵢ∥ being the length of the segment eᵢ;
the nodes of the alignable mesh defining positions for connectors that join together the beams of the preform, said connectors allowing the beams to be joined together during the step of manufacturing the structure, the preform being in its almost-linear compact configuration, in the form of a bundle, and being such that for each of its beams, the distance between two adjacent connectors on the beam is not necessarily constant.

In the remainder of the description, the term “beam” refers to any longitudinal structural element whose length is greater than the width, for example, without this list being exhaustive, a ring, a tube with a round or rectangular cross section, a bar with a rectangular cross section, a profiled element with a C-shaped cross section or an angle.

The potentially rectilinear configuration obtained for the alignable mesh substantially corresponds to the almost-linear shape obtained for the three-dimensional structure in its compact first configuration. Indeed, the “pure” rectilinear configuration is unachievable for the structure due to the non-zero thickness of the beams composing it. “Rectilinear configuration” refers to a configuration of a mesh wherein all the nodes are on the same straight line. “Almost-linear” is understood to mean any almost-rectilinear or almost-curvilinear geometric shape, in the form of a bundle, whose diameter is very small relative to the length of the assembly, typically whose diameter/length ratio is substantially less than 1/5.

The almost-linear bundle-shaped preform may be tubular, that is, defining a geometric shape that is closed on itself. In the context of the present invention, the term “tubular” in fact designates not only a simple tubular shape, but also more generally any mesh topology closed on itself and having an opening at each of its ends. Alternatively, the almost-linear preform in the form of a bundle may very well be non-tubular.

The manufacturing method according to the invention advantageously allows a compact three-dimensional structure to be obtained simply which has a high structural strength combined with ease of deployment and transport. It further allows any new geometric shapes to be achieved for the structure, not yet obtained via the manufacturing methods of the prior art. Such geometric shapes rely on obtaining discretized, so-called alignable meshes, which form irregular grids (that is, whose side lengths are not necessarily constant) and are generated at the end of the first step of the method. Such alignable meshes provide greater freedom to be able to adjust the shape of an elastic gridshell relative to a regular gridshell, with a constant mesh length. This adjustment capacity can for example be used to optimize the shape of the gridshell in order to improve the mechanical performance thereof, or else to reduce the permanent curvature of the beams (which in particular allows the use of thicker, and therefore stronger, beam sections), or else to allow the mesh to be aligned with an edge (for example, so that the edge of the mesh coincides with connections and not with intermediate portions of the segments), or else for the purpose of planarizing any cover panels attached to the joining connectors (which facilitates the manufacture thereof).

Furthermore, unlike the methods of the prior art, the method according to the invention does not perform a complete simulation of the deployment movement of the irregular gridshell, but guarantees the deployable nature of the latter via a simple local constraint. This allows a substantial reduction of the combinatorial complexity of the calculations carried out by the computer, without harming the deployable and structurally strong nature of the structure. A substantial gain in memory space and a reduction of the computing resources used for the calculations are thus obtained. These various benefits and technical effects are indifferent to the semantics of the data used.

According to a particular technical characteristic of the invention, the alignable mesh is generated from an initial discretized quadrangle mesh, and the alignable mesh is obtained by deformation of the quadrangles of the initial discretized quadrangle mesh.

In particular, and according to a first embodiment of the invention, the first generating step consists of a digital optimization method based on iterative projections on said initial discretized quadrangle mesh, one of said projections being carried out quadrangle after quadrangle by means of a projection operator able to deform any quadrangle into a so-called alignable quadrangle, a quadrangle being said to be alignable if, for an oriented path traveled along a closed loop coinciding with the sides of the quadrangle, said equation (1) is verified. This projection carried out by the projection operator may be used simultaneously with other projections, in particular allowing control of the position of the vertices representing the anchor points of the structure, to model the bending and torsional behavior of the beams, to limit the side length variations, and to ensure that the mesh is close to a reference surface.

Advantageously, during the first generating step, one of the iterative projections is carried out on the initial discretized quadrangle mesh by further means of an additional projection operator, said additional operator being able to deform any discretized quadrangle mesh so that the sides of the mesh correspond to pseudo-geodetic lines, a pseudo-geodetic line being defined as a line on a reference surface whose angle between the osculating plane and the normal to the surface is identical at each point, the mesh obtained at the end of the first generating step being an alignable mesh consisting of sides that follow almost-geodetic lines, the beams of the three-dimensional structure being profiles or bars whose cross section moment of inertia is much greater along one axis than along another axis, for example flat bars. Such bars are arranged, during the second step, so as to follow the almost-geodetic lines defined by the alignable mesh. This allows a three-dimensional structure to be obtained that naturally and easily deploys toward its deployed second configuration, virtually “all by itself,” while minimizing the use of temporary supports like tie-rods, cables or scaffoldings which are generally necessary to accompany the deployment of such a structure toward its final deployed configuration. The deployment of the structure toward its final three-dimensional shape is thus greatly facilitated.

According to a second embodiment of the invention, the first generating step comprises a phase consisting of an algorithmic minimization method of a function having several variables and several terms, the variables of said function being the geometry of the initial discretized quadrangle mesh, one of the terms of the function being an energy representative of the alignable nature of the mesh, for example an energy defined as follows:

$${E}_{alignable} = {\sum }_{quadrangles} {( {P}_{i , j} {P}_{i + 1 , j} + {P}_{i + 1 , j} {P}_{i + 1 , j + 1} - {P}_{i , j} {P}_{i , j + 1} - {P}_{i , j + 1} {P}_{i + 1 , j + 1} )}^{2} ; \qquad ( 3 )$$

the nodes of the mesh being indexed {P_{i,j}, (i, j)∈I, I⊂Z²}, the minimum of said energy being reached if the mesh is alignable, each of the other terms of the function being representative of desired geometric or mechanical properties for the three-dimensional structure.

According to a particular technical characteristic of the invention, if the initial discretized quadrangle mesh is simply connected, in other words if it lacks mesh holes, and all of its interior nodes are linked to exactly four sides, the nodes being indexed {P_{i,j}, (i, j)∈I, I⊂Z²}, then the generated mesh is said to be alignable if, for any elementary quadrangle of the mesh having vertices P_{i,j}, P_{i+1,j}, P_{i+1,j+1}, P_{i,j+1}, the side lengths of said quadrangle satisfy the following equation:

$${P}_{i , j} {P}_{i + 1 , j} + {P}_{i + 1 , j} {P}_{i + 1 , j + 1} = {P}_{i , j} {P}_{i , j + 1} + {P}_{i , j + 1} {P}_{i + 1 , j + 1} ; \qquad ( 2 )$$

said vertices being nodes of the mesh.

According to another particular technical feature of the invention, the alignable mesh and/or the initial discretized quadrangle mesh are three-dimensional meshes.

According to another particular technical feature of the invention, the initial discretized quadrangle mesh is a rotational-symmetric mesh or a Chebyshev mesh, in particular of the Chebyshev plane mesh type. Such a Chebyshev mesh is a mesh having a constant side length.

According to another embodiment of the invention, the first step of generating an alignable mesh comprises a first phase consisting in defining a first pseudo-geodetic line on a surface of revolution, a pseudo-geodetic line being defined as a line on a reference surface whose angle between the osculating plane and the normal to the surface is identical at each point; a second phase consisting in duplicating the first pseudo-geodetic line by rotation about the axis of revolution of the surface of revolution, thus providing a first set of pseudo-geodetic lines, and a third phase consisting in symmetrizing the pseudo-geodetic lines obtained during the second phase with respect to a plane containing said axis of revolution, providing a second set of pseudo-geodetic lines, the first and second sets of pseudo-geodetic lines constituting the alignable mesh.

Advantageously, the method further comprises, before the second step, an intermediate step, implemented by computer, comprising a first phase of modeling additional elements such as braces, spacers or additional cables present on the structure, and a second phase of releasing one or more constraints on the geometry of the alignable mesh, in order to obtain a mesh geometry allowing structural equilibrium to be achieved taking into account said additional elements, this intermediate step being carried out following or in parallel with the first step. This intermediate step ensures the mechanical equilibrium of the structure in its deployed second configuration. Such an intermediate step is particularly important if the three-dimensional structure requires many braces, cables and/or spacers. Indeed, it allows the presence of these elements to be taken into account.

Advantageously, the second phase of releasing one or more constraints on the geometry of the alignable mesh comprises implementing a mechanical model of the beams, in particular a model of projective dynamics, dynamic relaxation or finite elements of the mechanics of the beams such as, for example, a model taking into account the axial behavior, the torsion and the biaxial bending, and/or implementing a model to impose position constraints on the edges. Using one or more of these models in particular makes it possible to model the beams as objects having axial stiffness, and thus to take their mechanical strength into account, as well as to obtain an alignable mesh with edges having a predetermined position.

According to a particular technical characteristic of the invention, the method further comprises, after the second step, a final step of applying deformations to the preform allowing a desired final flared shape to be achieved that corresponds to the deployed second configuration of the three-dimensional structure, said application step comprising the following phases:
the upper part of the preform is connected to the floor by tie-rods so as to maintain the flared shape of the structure during the installation of straps and/or spacers and/or cables, or
said preform is pressed on the floor so that a flared part of the preform is placed on the floor, then straps and/or spacers and/or cables are placed, then the structure is turned over so that its flared part is located upward.

According to another aspect, the invention also relates to a computer program product that can be downloaded from a communication network and/or recorded on a computer-readable medium and/or executed by a processor, the computer program product comprising program instructions, said program instructions implementing at least the step of generating the alignable mesh of the method as described above when said instructions are executed on a processing unit of a computing device.

Such a computer program product in particular has the advantage of being able to be incorporated typically into a generic tool for designing shapes, and does not require its own optimization environment to be able to operate. Such a computer program product thus provides a particularly intuitive solution to allow deployable three-dimensional structures to be obtained having a wide variety of geometric shapes.

According to another aspect, the invention also relates to a three-dimensional structure deployable between a compact first configuration and a deployed second configuration, the three-dimensional structure comprising elastically deformable beams joined together by connectors, the three-dimensional structure being manufactured via the method as described above, the three-dimensional structure forming an element from the group consisting of: an urban furniture element or an urban architecture element, a satellite module or a spacecraft, a submarine module, a temporary or non-temporary shelter, a show and/or entertainment decorative element, a toy, a support (for example for vegetation or a solar panel), a reinforced concrete shell reinforcement, and a permanent or temporary concrete shell formwork. In the case of a reinforced concrete shell reinforcement, the three-dimensional structure according to the invention may indeed be used to manufacture a curved reinforcement, such curved reinforcements generally being difficult to obtain in the building sector. In the case of a concrete shell formwork, the three-dimensional structure according to the invention may advantageously serve as temporary support for the time needed for the concrete to dry.

Advantageously, each joining connector within the structure is a connector joining two beams and allowing rotation between these two beams according to a single degree of freedom. This allow further facilitating of the deployment of the structure toward its final three-dimensional shape when the method for manufacturing the structure comprises an intermediate phase consisting in causing the generated alignable mesh to consist of sides that follow pseudo-geodetic lines during the first step.

According to a particular technical characteristic of the invention, each joining connector within the structure is made up of two parts pivotally mounted relative to one another about a common axis, the two parts being arranged on one another and being crossed by the axis, each part being configured to receive and hold a beam, for example by means of an oblique receiving and holding slot provided in the part, each part assuming a pierced tapered shim geometry.

According to another particular technical feature of the invention, each joining connector within the structure is a connector joining two beams and allowing rotation between these two beams according to three degrees of freedom, each connector being formed by an axis and two tapered shims, the two tapered shims being positioned between the beams and being crossed by the axis, each tapered shim supporting one of the beams and being configured to be able to rotate relative to said beam.

According to another particular technical feature of the invention, the three-dimensional structure is held by means selected from the group comprising straps, spacers, beam joining devices, and cables.

According to another aspect, the invention also relates to a group of three-dimensional structures connected to one another, at least one of the three-dimensional structures being as described above, the structures preferably being interconnected in their larger ranging area.

### BRIEF DESCRIPTION OF THE FIGURES

The aims, advantages and features of the method for manufacturing a deployable three-dimensional structure according to the invention will become more clearly apparent in the following description on the basis of at least one non-limiting embodiment shown by the drawings, wherein:

FIG. 1 is a schematic depiction of a computer, comprising a processing unit and memory means storing an application able to implement fewer steps of a manufacturing method according to the invention;

FIG. 2 is a flowchart depicting the method for manufacturing a deployable three-dimensional structure according to one embodiment of the invention;

FIG. 3 is a schematic depiction of a particular step of the method of FIG. 2, showing the depiction of an oriented path traveled along a closed loop and composed of oriented path segments, where each segment coincides with a side of a mesh;

FIG. 4 is a schematic depiction of a particular step of the method of FIG. 2, showing an alignable quadrangle in a simply connected quadrangle mesh;

FIG. 5 is a schematic depiction of a particular step of the method of FIG. 2, showing deformations carried out by a projection operator on any quadrangle to make it alignable,

FIG. 6 is a schematic depiction of pseudo-geodetic lines alignable on a sphere;

FIG. 7 is a schematic depiction of a particular step of the method of FIG. 2, showing the generation of discrete pseudo-geodetic lines;

FIG. 8 is a perspective view of a beam of the deployable three-dimensional structure and a part of a joining connector according to a first particular embodiment, such a connector allowing rotation between the two beams according to a single degree of freedom;

FIG. 9 is a perspective view of a set of two beams of the deployable three-dimensional structure, assembled via the joining connector according to the example embodiment of FIG. 8;

FIG. 10 is a perspective view of a set of two beams of the deployable three-dimensional structure, assembled via a joining connector according to a second particular embodiment;

FIG. 11 is a perspective view of a set of four profiles of the deployable three-dimensional structure, assembled via a joining connector according to a third particular embodiment;

FIG. 12 shows, in perspective, a first example of a deployable three-dimensional structure obtained via the manufacturing method according to the invention, seen superimposed both in its compact first configuration and in its deployed second configuration;

FIG. 13 is a top view of the first example deployable three-dimensional structure, in its deployed second configuration;

FIG. 14 shows, in perspective, a second example of a deployable three-dimensional structure obtained via the manufacturing method according to the invention, seen superimposed both in its compact first configuration and in its deployed second configuration;

FIG. 15 is a top view of the second example deployable three-dimensional structure, in its deployed second configuration shown in FIG. 14; and

FIG. 16 shows, in perspective, a third example of a deployable three-dimensional structure obtained via the manufacturing method according to the invention.

### DETAILED DESCRIPTION OF THE INVENTION

In the remainder of the description, “computer” refers to any electronic device structured according to an architecture of the “von Neumann” type and provided with a data processing unit, as well as data storage means, such as for example a desktop computer, a laptop computer, a wireless communication apparatus such as a smartphone, or a digital tablet, this list not being exhaustive.

The term “quadrangle” is further understood to mean any closed geometric figure, flat or not, having four vertices and four sides connecting these vertices.

The term “side” is further understood to mean any straight or curved line connecting two vertices of a quadrangle.

“Chebyshev mesh” is also understood to mean any discretized quadrangle mesh having a constant side length.

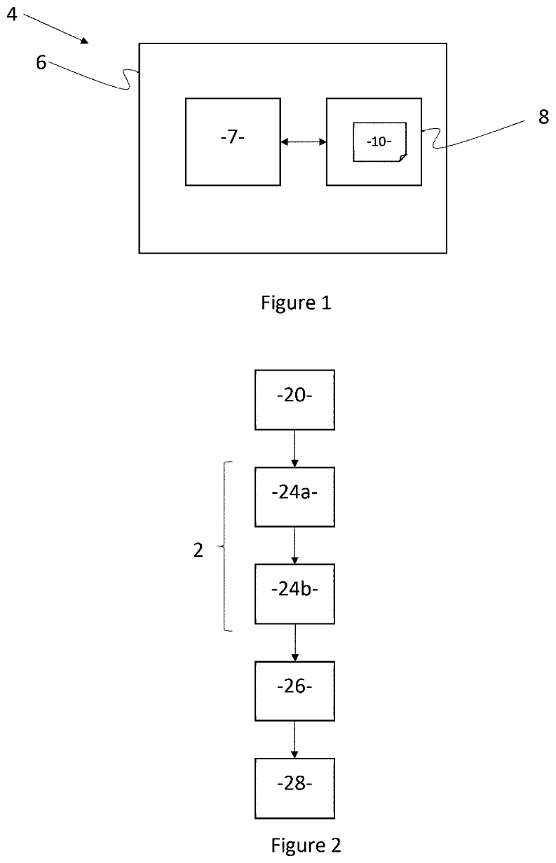

In the following, in particular, a method for manufacturing a deployable three-dimensional structure 2 is disclosed. A computer 4 is depicted schematically in FIG. 1. The computer 4 is provided with a processing unit 6. The processing unit 6 e.g. comprises a processor 7 and storage means 8 connected to the processor 7. The storage means 8 store an application 10.

The application 10 is able to be executed by the processor 7 of the processing unit 6, and comprises instructions for the execution of at least one step of the manufacturing method according to the invention, as will be detailed below. The application 10 is for example a downloadable application, via a download platform not shown in the figures.

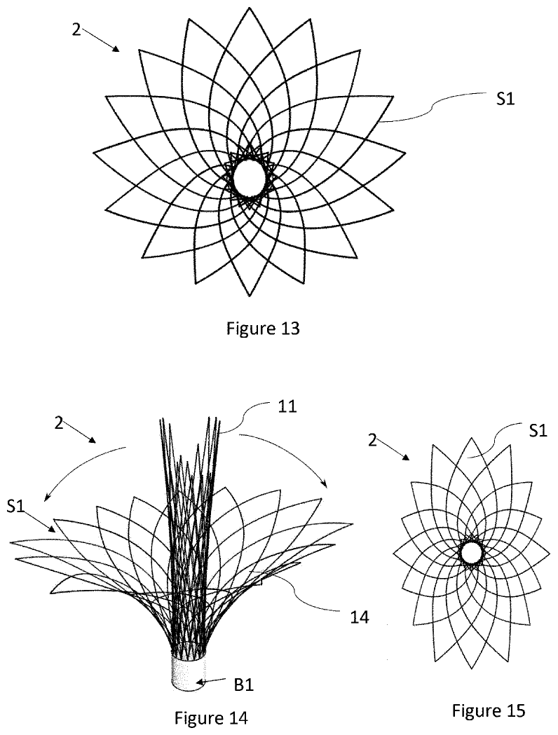

As shown in FIGS. 12 to 16, the three-dimensional structure 2 is an elastic gridshell comprising a set of elastically deformable beams 11, as will be detailed below. The beams 11 are interconnected so as to produce a mesh 14. The three-dimensional structure 2 is deployable between a compact first configuration, shown for example in FIGS. 12 and 14, and at least one deployed second configuration, such a deployed configuration being shown in particular in FIGS. 12 to 16. The structure 2 forms for example an element selected from the group consisting of: an urban furniture or urban architecture feature, a satellite module or a spacecraft, a submarine module, a temporary or non-temporary shelter, a toy, a support (for example for vegetation, solar panel, masonry roof), a show and/or entertainment decorative element, a reinforced concrete shell reinforcement, and a permanent or temporary concrete shell formwork, this list not being limiting. Alternatively, in fact, the structure 2 may form any other type of element that is not listed above.

The method for manufacturing the deployable three-dimensional structure 2 according to the invention will now be described in detail, in particular with reference to FIG. 2. It is assumed that initially the application 10 is executed by the processor 7 of the processing unit 6.

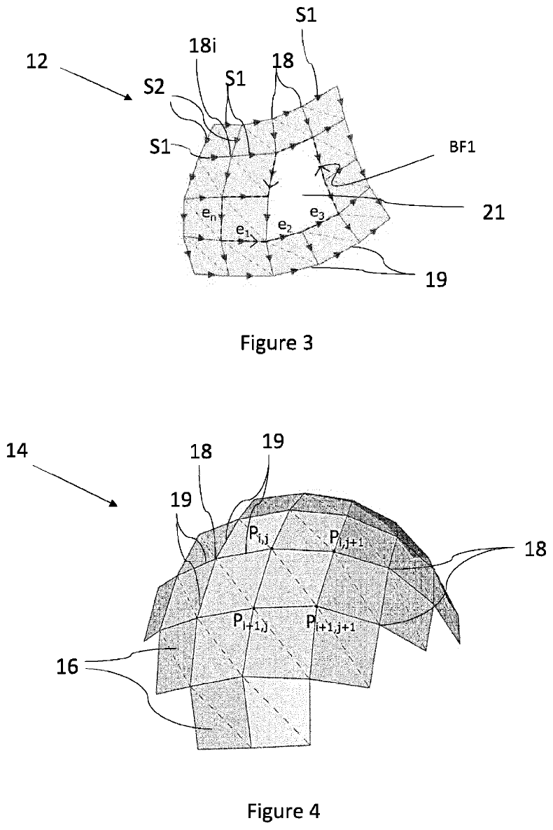

The method comprises an initial step 20, implemented by the processing unit 6 of the computer 4, during which a so-called alignable mesh 14 is generated. According to a particular embodiment of the invention, the alignable mesh 14 is generated from an initial discretized quadrangle mesh 12. Such an example of a initial discretized quadrangle mesh 12 (hereinafter called initial mesh 12) is visible in FIG. 3. In addition to the quadrangles 16, the initial mesh 12 also comprises a predetermined number of nodes 18 interconnected by sides 19. The sides 19 are in this case preferentially straight sides. The alignable mesh 14 is obtained by deformation of the quadrangles 16 of the initial mesh 12. Preferably, this deformation of the quadrangles 16 is carried out by the application 10 quadrangle after quadrangle, as will be detailed below. The initial mesh 12 and the alignable mesh 14 are preferentially three-dimensional meshes, although in a variant two-dimensional meshes may also be used. According to a particular embodiment of the invention, the initial mesh 12 is a Chebyshev mesh, in particular of the Chebyshev plane mesh type. Other initial meshes 12 may be used, such as, for example, rotational meshes (with rotational symmetry) or translational meshes. However, this is in no way limiting within the scope of the method that is the subject of the present invention and the first step 20 of said method applies in the same way to any discretized initial mesh 12, with any quadrangles.

As shown in FIG. 3, the application 10 assigns each side 19 a predetermined orientation chosen from two possible orientations S1, S2. The sides 19 of the mesh 12, 14 are oriented coherently. Each elementary quadrangle 16 of the mesh 12, 14 has a first pair of opposite sides 19a oriented in a first orientation S1, and a second pair of opposite sides 19b oriented in a second orientation S2, distinct from the first orientation S1. Additionally, each interior node 18 of the mesh 12, 14 is joined to four sides 19, the sides of a pair of sides opposite this node 18 having the same orientation S1, S2. This is visible in FIG. 3 for a particular node 18i, but applies in the same way to all the interior nodes of the mesh 12, 14. This property imposes a continuous and coherent orientation of the sides 19 within the mesh 12, 14. In general, and as shown in FIG. 3, mesh holes 21 may exist within the mesh 12, 14.

A discretized quadrangle mesh 14 is said to be alignable if, for any oriented path traveled along a closed loop BF1 and composed of oriented path segments {e₁, . . . , eₙ}, where each segment coincides with a side 19 of the mesh 14, the following equation is verified for this path:

$${Σ}_{i = 1}^{n} {ε}_{i} ‖ {e}_{i} ‖ = 0 ; \qquad ( 1 )$$

with: εᵢ=+1 if the segment eᵢ has the same orientation as the coincident side 19 of the mesh, and εᵢ=−1 otherwise. ∥eᵢ∥ is the length of the segment eᵢ. Path segments {e₁, . . . , eₙ} are of course oriented in the same direction along the closed loop BF1.

In other words, the mesh 14 is said to be alignable if such a mesh can be deformed into a rectilinear configuration by angularly modifying the mesh 14 at its nodes 18 and keeping constant lengths of the sides 19. The alignable nature of a mesh is a purely metric property, and is thus retained by isometric deformations of the mesh.

In the particular case where the mesh 14 is simply connected, in other words, if it lacks mesh holes 21 and all of its interior nodes 18 are connected to exactly four sides 19, an alternative (purely local) definition of the alignable nature of the mesh 14 can be given. Such a situation is shown in FIG. 4. The nodes 18 of the mesh 14 are indexed {P_{i,j}, (i, j)∈I, I⊂Z²}. The mesh 14 is then said to be alignable if, for any elementary quadrangle 16 of the mesh 14 having vertices P_{i,j}, P_{i+1,j}, P_{i+1,j+1}, P_{i,j+1}, the lengths of the sides 19 of this quadrangle satisfy the following equation:

$${P}_{i , j} {P}_{i + 1 , j} + {P}_{i + 1 , j} {P}_{i + 1 , j + 1} = {P}_{i , j} {P}_{i , j + 1} + {P}_{i , j + 1} {P}_{i + 1 , j + 1} ; \qquad ( 2 )$$

The vertices P_{i,j}, P_{i+1,j}, P_{i+1,j+1}, P_{i,j+1} of the quadrangle 16 of course form part of the nodes 18 of the mesh 14.

If the mesh 14 is alignable mesh, for any quadrangle 16 of the mesh, equation (2) is satisfied: it is obtained by applying equation (1) to the closed loop formed by the four sides of the quadrangle. Reciprocally, for an alignable and simply connected mesh 14, if for a given closed loop, each quadrangle 16 included in the loop verifies equation (2), equation (1) is obtained by adding equations (2) of each quadrangle 16.

According to a first embodiment of the invention, the first generating step 20 consists of a digital optimization method, carried out by the application 10, and based on iterative projections on the initial discretized quadrangle mesh 12. “Projection” is understood to mean any geometric operation, carried out by means of one or more projection operators, which displaces initial mesh nodes, associated with one or more predetermined geometric constraints, to new positions (final positions of the nodes) wherein these nodes satisfy the geometric constraint(s) in question.

According to this first embodiment, one of these iterative projections is carried out quadrangle 16 after quadrangle 16 by means of a projection operator able to deform any quadrangle into a so-called alignable quadrangle. A quadrangle 16 is said to be alignable if, for an oriented path traveled along a closed loop coinciding with the sides 19 of the quadrangle 16, equation (1) is verified. As seen previously, in the particular case where the mesh 14 is simply connected, a quadrangle 16 is said to be alignable if equation (2) is verified for this quadrangle.

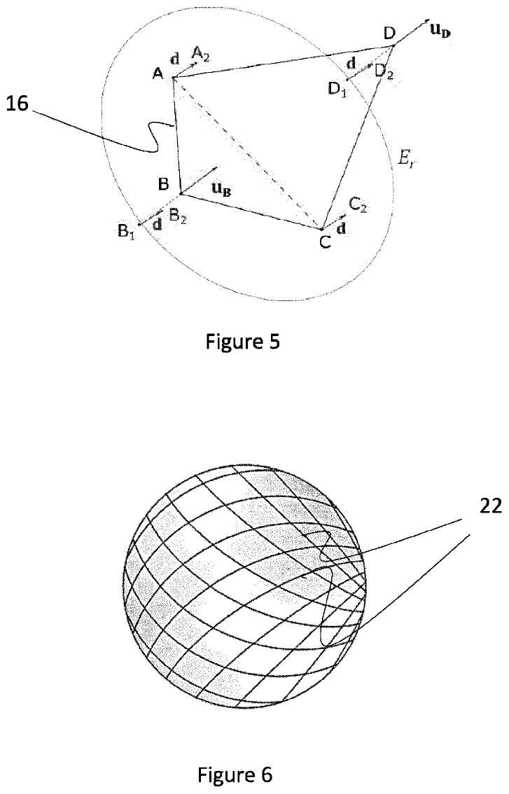

For example, a first projection operator can be used, which modifies an arbitrary quadrangle ABCD by deforming it into an alignable quadrangle A₂B₂C₂D₂ with a small displacement of its vertices. This deformation, shown in FIG. 5, is called a projection and is calculated in two steps.

### Step 1: 1st Order Projection of B and D

It should be noted that making a quadrangle alignable is equivalent to minimizing the energy:

$${E}_{a l} = {( A B + B C - C D - D A )}^{2} = {e}^{2} ; \qquad ( 3 )$$

Where e=AB+BC−CD−DA is called the alignment error. It is equal to 0 for an alignable quadrangle, and is otherwise positive. The application 10 chooses the projection directions into B and D based on the opposite of the gradient of this quantity. This direction corresponds to the bisectors of the quadrangle:

$${∇}_{B} {E}_{a l} = e ( \vec{\frac{A B}{A B}} + \vec{\frac{C B}{C B}} ) ; \qquad ( 4 )$$

$${∇}_{D} {E}_{a l} = e ( \vec{\frac{D C}{D C}} + \vec{\frac{D A}{D A}} ) ; \qquad ( 5 )$$

The importance of the sign of e should be noted. In FIG. 5, AB+BC>CD+DA, therefore e>0. The application 10 calls these two directions, which intersect, u_{B} and u_{D} (FIG. 5). By convention, it is chosen that l₁=AB+BC, l₂=AD+DC and their average value lₘ=(l₁+l₂)/2. The application 10 then searches the points B′=B+t_{B}u_{B}, t_{B}∈ [symbol] and D′=D+t_{D}u_{D}, t_{D}∈ [symbol] so that:

$${AB}^{′} + {B}^{′} C = {CD}^{′} + {D}^{′} A = {l}_{m} ; \qquad ( 6 )$$

This is equivalent to projecting B and D on an ellipsoid of revolution Eᵣ with foci A and C and which is as close as possible to both B and D. This amounts to solving, in t_{B} and t_{D}:

$$dist ( B + {t}_{B} {u}_{B} , A ) + dist ( D + {t}_{B} {u}_{B} , A ) = {l}_{m} ; \qquad ( 7 )$$

$$dist ( D + {t}_{D} {u}_{D} , A ) + d i s t ( D + {t}_{D} {u}_{D} , A ) = {l}_{m} ; \qquad ( 8 )$$

These two equations are non-linear. However, an exact resolution is not necessary given the iterative method used (see the details below). The application 10 therefore resolves these first-order equations by linearizing them at t_{B}=0 and t_{D}=0. The application 10 evaluates the slopes by a discrete difference pattern. The solutions give points B₁ and D₁, which lie approximately on the ellipse Er.

### Step 2: Correction of the Rigid Body

In a second step, a translation is applied to the four points A, B₁, C, D₁ by a vector d. This gives points A₂B₂C₂D₂. The application 10 chooses d such that the center of gravity of these four points A₂B₂C₂D₂ coincides with the center of gravity of the four initial points. In doing so, points A and C move in a direction close to the gradient of Eₐₗ, given by:

$${∇}_{A} {E}_{a l} = e ( \vec{\frac{B A}{B A}} + \vec{\frac{A D}{A D}} ) ; \qquad ( 9 )$$

$${∇}_{C} {E}_{a l} = e ( \vec{\frac{B C}{B C}} + \vec{\frac{C D}{C D}} ) ; \qquad ( 10 )$$

The projection direction is therefore close to that followed by a gradient descent algorithm on Eₐₗ.

The iterative projections are then carried out by the application 10, quadrangle 16 after quadrangle 16, by iterations of the two steps detailed below (which are similar to those presented in Bouaziz et al. 2012: “Shape-Up: Shaping Discrete Geometry with Projections” and in Deuss et al 2015: “ShapeOp—A Robust and Extensible Geometric Modelling Paradigm”):
local step: a candidate shape is calculated for each set of points that are commonly influenced by a constraint. For a geometric constraint, this amounts to giving the points a shape that satisfies the constraint. For a physical constraint, this amounts to finding the closest positions of points that have a zero physical potential (for example, an elastic deformation energy).
global step: the candidate shapes calculated in the local step are generally incompatible. The global step resolves a new set of positions of coherent points so that each set of points subjected to a common constraint is as close as possible to the corresponding candidate shape.

In practice, the geometric constraints are encoded by projections carried out by different projection operators (including the projection operator described above), such projections being applied to the local step. These projections in particular make it possible to control the position of the vertices representing the anchor points of the structure, model of the bending and torsional behavior of the beams, limit the side length variations, and ensure that the mesh is close to a reference surface.

The global step is typically carried out by performing a minimization of the weighted least squares type, this minimization relating to the distances connecting each point to the locations where it was projected for each constraint. This global step gives a geometry that only approximately verifies the desired constraints, which is why iterations are necessary. The fact that the projection carried out via the projection operator described above is approximate is therefore not a problem, especially since this approximation becomes increasingly precise as the algorithm converges (B and D are then increasingly close to the ellipsoid of revolution Eᵣ).

Preferably, according to this first embodiment, a second projection operator is used during the generating step 20, this second projection operator being able to deform any discretized quadrangle mesh 12 so that the sides 19 of the mesh 12 correspond to pseudo-geodetic lines 22. A pseudo-geodetic line is defined as being a line on a reference surface; the angle between the osculating plane and the normal to the surface is identical at each point. Such pseudo-geodetic lines 22 are for example visible in FIG. 6, in the case where the reference surface is a sphere. The mesh 14 obtained at the end of the first generating step 20 is then an alignable mesh consisting of sides 19 that follow pseudo-geodetic lines.

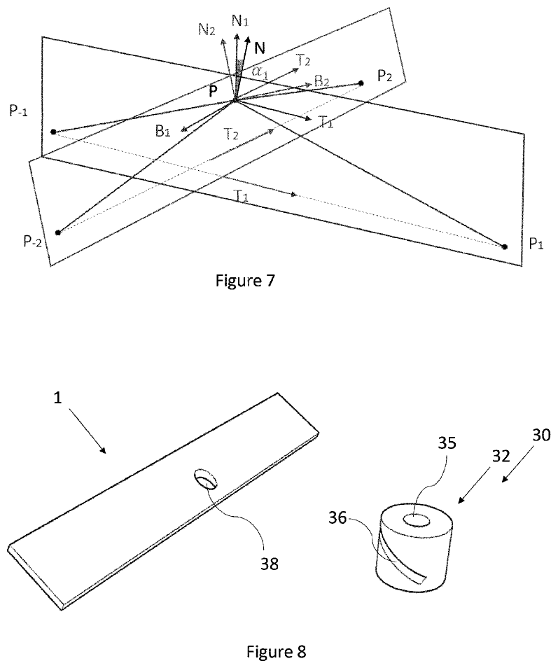

A model for generating discrete pseudo-geodetic lines is introduced below with reference to FIG. 7.

The application 10 first breaks down oriented polylines into family 1 and family 2. The application 10 names the neighbors of a vertex or node P, respectively, P₁, P₋₁ in the direction 1 and P₂, P₋₂ in the direction 2 (see FIG. 7).

The application 10 then defines the Frenet mark at the point P:

### Tangent Vectors:

$$\vec{{T}_{1}} = \frac{\vec{{P}_{- 1} {P}_{1}}}{{P}_{- 1} {P}_{1}} ; \vec{{T}_{2}} = \frac{\vec{{P}_{- 2} {P}_{2}}}{{P}_{- 2} {P}_{2}}$$

### Binormal Vectors:

$$\vec{{B}_{1}} = {b}_{1} \frac{\vec{{P}_{- 1} P} ⋀ \vec{{P}_{- 1} {P}_{1}}}{‖ \vec{{P}_{- 1} P} ⋀ \vec{{P}_{- 1} {P}_{1}} ‖} ; \vec{{B}_{2}} = {b}_{2} \frac{\vec{{P}_{- 2} P} ⋀ \vec{{P}_{- 2} {P}_{2}}}{‖ \vec{{P}_{- 2} P} ⋀ \vec{{P}_{- 2} {P}_{2}} ‖}$$

Wherein b₁=±1 and b₂=±1 wherein the sign is chosen to obtain a consistent orientation of the binormals with those of the neighboring vertices.

### Normal Vectors:

$$\vec{{N}_{1}} = \frac{\vec{{B}_{1}} ⋀ \vec{{T}_{1}}}{‖ \vec{{B}_{1}} ⋀ \vec{{T}_{1}} ‖} ; \vec{{N}_{2}} = \frac{\vec{{B}_{2}} ⋀ \vec{{T}_{2}}}{‖ \vec{{B}_{2}} ⋀ \vec{{T}_{2}} ‖}$$

The application 10 also defines the normal vector at the surface approximated by the network of curves by:

$$\vec{N} = \frac{\vec{{T}_{1}} ⋀ \vec{{T}_{2}}}{‖ \vec{{T}_{1}} ⋀ \vec{{T}_{2}} ‖}$$

The application 10 defines discrete pseudo-geodetic networks as networks for which the angles α₁=\vec{N} [symbol] \vec{N₁} and α₂=\vec{N} [symbol] \vec{N₂} are constant.

Then, at each iteration of the global step described above, the application 10 implements the following projections, via the second projection operator:
the application 10 defines target angles α₁ and α₂ of inclination of the beams relative to a reference surface (this surface is abstract, it is not constructed));
at each point P:
the application 10 calculates the tangent vectors

$$\vec{{T}_{1}} = \frac{\vec{{P}_{- 1} {P}_{1}}}{{P}_{- 1} {P}_{1}} ; \vec{{T}_{2}} = \frac{\vec{{P}_{- 2} {P}_{2}}}{{P}_{- 2} {P}_{2}}$$

the application 10 calculates the normal

$$\vec{N} = \frac{\vec{{T}_{1}} ⋀ \vec{{T}_{2}}}{‖ \vec{{T}_{1}} ⋀ \vec{{T}_{2}} ‖}$$

the application 10 then calculates the target osculating plane Plane_{oc1}:
the application 10 calculates the vector \vec{N_{oc1}} by rotation of the vector N by an angle α₁ around \vec{T₁}.
the application 10 calculates the point G₁ as the identical weight barycenter of the points P, P₁, P₋₁.
the application 10 defines the plane Plane_{oc1} as the plane passing through G₁ and oriented by the vectors \vec{T₁} and \vec{N_{oc1}}.
the application 10 then performs the same operations to construct the plane Plane_{oc2}:
the application 10 calculates the vector \vec{N_{oc2}} by rotation of the vector \vec{N} by an angle α₂ around \vec{T₂}.
the application 10 calculates the point G₂ as the identical weight barycenter of the points P, P₂, P₋₂.
the application 10 defines the plane Plane_{oc2} as the plane passing through G₂ and oriented by the vectors \vec{T₂} and \vec{N_{oc2}}.
finally, the projections applied by the application 10 are as follows:
the application 10 projects the points P, P₁, P₋₁ on the plane Plane_{oc1};
the application 10 projects the points P, P₂, P₋₂ on the plane Plane_{oc2};
Two different projections calculated for the point P, which are combined in the global step described above, are therefore obtained.

According to a second embodiment of the invention, the first generating step 20 comprises a phase, carried out by the application 10, consisting of an algorithmic minimization method of a function having several variables and several terms. The variables of the function are the geometry of the initial discretized quadrangle mesh 12. The nodes 18 of the mesh are indexed {P_{i,j}, (i, j)∈I, I⊂Z²}. One of the terms of the function is an energy representative of the alignable nature of the mesh, for example an energy defined as follows:

$${E}_{alignable} = {\sum }_{quadrangles} {( {P}_{i , j} {P}_{i + 1 , j} + {P}_{i + 1 , j} {P}_{i + 1 , j + 1} - {P}_{i , j} {P}_{i , j + 1} - {P}_{i , j + 1} {P}_{i + 1 , j + 1} )}^{2} ; \qquad ( 3 )$$

Energy E_{alignable} is the same as the energy Eₐₗ defined above. The minimum energy E_{alignable} is reached if the mesh 14 is alignable, each of the other terms of the function being representative of desired geometric or mechanical properties for the three-dimensional structure 2.

According to another particular embodiment (not shown in the figures), the alignable mesh 14 is generated during step 20 no longer from an initial discretized quadrangle mesh, but via the following successive phases:
during a first phase, the application 10 defines a first pseudo-geodetic line on a surface of revolution. Such a pseudo-geodetic line can be traced for example by the method described in Jiang et al 2019 “Curve-Pleated Structures”: for a given point and starting direction on the surface, it is possible to construct, by integration, a pseudo-geodetic line starting from the point and whose initial tangent coincides with the desired direction;
during a second phase, the application 10 duplicates this first pseudo-geodetic line by rotations about the axis of revolution of the surface of revolution, such that the angles of these rotations form an algebraic series (for example 0°, 10°, 20°, . . . 90°). These curves thus provide a first set of pseudo-geodetic lines;
during a third phase, the pseudo-geodetic lines obtained during the second phase are symmetrized relative to a plane containing the axis of revolution, providing a second set of pseudo-geodetic lines.

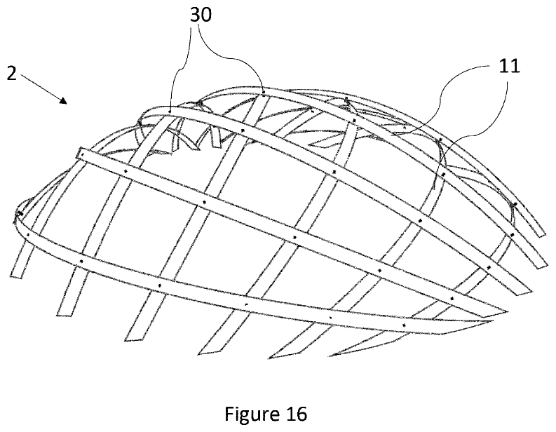

The first and second sets of pseudo-geodetic lines then constitute the alignable mesh 14. Unlike the previous cases, the sides 19 of this mesh 14 are curved, and thus constitute a better approximation of the geometry of a gridshell. It will be possible to retain only a portion of the mesh thus generated for the geometry of the final structure. An example of a final structure 2 obtained via the method according to this particular embodiment is for example visible in FIG. 16.

Preferably, the method comprises a following step 24, implemented by the processing unit 6 of the computer 4. Step 24 comprises a first phase 24a for modeling additional elements such as braces, spacers or additional cables present on the structure 2, and a second phase 24b during which one or more constraints relating to the geometry of the alignable mesh 14 are released. These constraints are released during the second phase 24b in order to obtain a mesh 14 geometry allowing structural equilibrium to be achieved for the structure 2 taking into account the additional elements described above. In an alternative that is not shown, the releasing step 24 is carried out in parallel with the step 20 of generating an alignable mesh 14.

Advantageously, the second phase 24b of releasing one or more constraints on the geometry of the alignable mesh 14 comprises implementing a mechanical model of the beams, in particular a model of projective dynamics, dynamic relaxation or finite elements of the mechanics of the beams such as, for example, a model taking into account the axial behavior, the torsion and the biaxial bending, and/or implementing a model to impose position constraints on the edges. This second phase 24b of releasing one or more constraints in particular allows modeling of the anchors, mechanics of the beams 11 and the specific weight load for the structure 2. If a sufficient number of anchors and braces is provided for the structure 2, the geometry deviates relatively little in this second phase 24b.

The method comprises a following step 26 for manufacturing the three-dimensional structure 2. The three-dimensional structure 2 is manufactured from the alignable mesh 14 obtained at the end of the first generating step 20. More specifically, the structure 2 is in its compact first configuration (shown for example in FIGS. 12 and 14) in the form of an almost-linear preform, in the form of a bundle. The almost-linear preform may have a tubular shape (for example substantially cylindrical or conical), or a non-tubular shape. The almost-linear preform comprises elastically deformable beams 11, interconnected via joining connectors 30. The nodes 18 of the alignable mesh 14 define positions for the joining connectors 30 between the beams 11. The three-dimensional structure 2 is such that for each of its beams 11, the distance between two adjacent connectors 30 on the beam 11 is not necessarily constant. At the end of the step 24 of releasing constraint(s), diagonal spacers, braces or cables (not shown in the figure) may be added within the structure 2.

The alignable mesh 14 thus constitutes an approximation of the geometry of the deployable three-dimensional structure or gridshell 2. The sides 19 represent the beams 11, while the nodes 18 represent the joining connectors 30. The main hypothesis of this model is that, in the deployed second configuration of the structure 2, the curvilinear length between two connections 30 is approximated by the Euclidean distance separating them. It is a satisfactory approximation if the elementary cell of the structure 2 is sufficiently fine (the error then being of the second order). However, there is no approximation in the almost-linear compact first configuration.

In the preferred embodiment according to which the mesh 14 obtained at the end of the first generating step 20 is an alignable mesh consisting of sides 19 that follow pseudo-geodetic lines, the beams 11 of the structure 2 are arranged so as to follow the pseudo-geodetic lines defined by this alignable mesh 14. In this case, the beams 11 are preferentially profiles or flat bars. “Profile” or “flat bar” means any beam with a rectangular cross section or any other type of cross section, having a significantly greater inertia in one direction than in another. This type of beam is thus easily curved in one direction, but not in the other. In addition, the torsional stiffness of the beam is relatively low. The pseudo-geodetic lines defined by the sides 19 of the alignable mesh 14 are used to determine the lengths between joining connectors 30 on each beam 11.

For example, returning to FIG. 7, the profiles or flat bars 11 may be placed along the sides 19 of the mesh 14, so that, for each profile or flat bar 11:
the center line of the profile or of the flat bar 11 is aligned with the vectors \vec{T₁}; \vec{T₂};
the axis of low inertia of the cross section of the profile or of the flat bar 11 is in the direction \vec{B₁}; \vec{B₂};
the axis of strong inertia of the cross section of the profile or of the flat bar 11 is in the direction \vec{N₁}; \vec{N₂}.

FIGS. 8 to 11 show a particular embodiment for the joining connectors 30 between the beams 11 of the structure 2, allowing an angle variation between these beams 11 without sliding. According to this particular embodiment, each joining connector 30 is a connector joining two beams 11 and allowing rotation between these two beams 11 according to a single degree of freedom. The beams 11 are preferentially profiles or flat bars. This particular embodiment of the joining connectors 30 is in fact particularly suitable for the preferred embodiment according to which the mesh 14 obtained at the end of the first generating step 20 is an alignable mesh consisting of sides 19 that follow pseudo-geodetic lines.

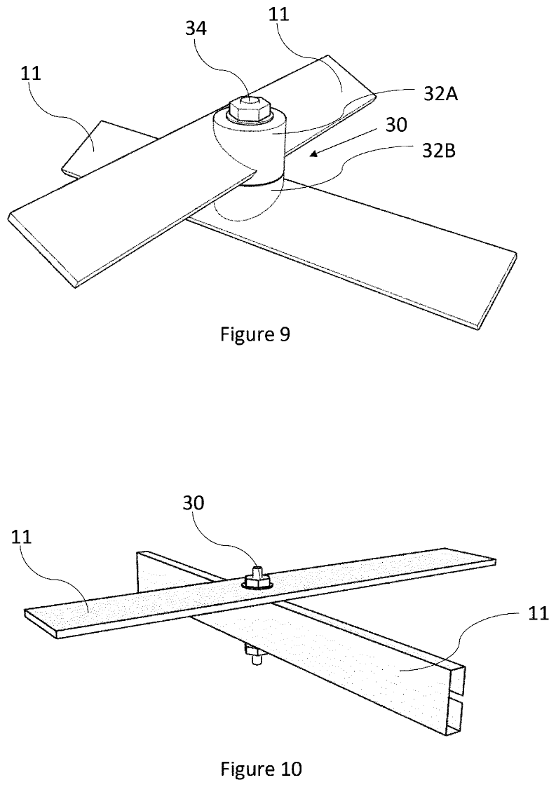

More specifically, and according to a first example shown in FIGS. 8 and 9, each connector 30 consists of two parts 32 pivotally mounted relative to one another about a common axis 34. The two parts 32, for example cylindrical, are arranged one on top of the other and are passed through by the axis 34 (a longitudinal bore 35 is for example provided in each part 32 to receive the axis 34). Each part 32 is configured to receive and hold a beam 11, typically by means of an oblique receiving and holding slot 36 provided in the part 32 and opening outside the part 32. Each part 32 may for example be made from an initial tube of great thickness, by cutting this tube and by making the oblique slot 36 therein by an angled saw line. Each part 32 thus assumes a pierced tapered shim geometry. In this way, the extension planes of the two beams 11 connected by the joining connector 30 intersect by forming a non-zero angle relative to one another, for example an angle substantially equal to 30 degrees. Such a non-zero angle imparts good mechanical strength to the structure 2. The overall result for the structure 2 is for example visible in FIG. 16, where the structure 2 according to this particular embodiment forms a sort of pseudo-geodetic dome. Such a dome is particularly interesting in that it naturally and very easily deploys toward its deployed configuration, virtually “by itself.” This allows elimination of the use of temporary supports like tie-rods, cables or scaffoldings.

According to this particular embodiment shown in FIGS. 8 and 9, the profiles or flat bars 11 may be connected in the following way to follow the pseudo-geodetic lines defined by the sides 19 of the alignable mesh 14:
a hole 38 is pierced obliquely or perpendicularly in the profiles or flat bars 11. The hole 38 is for example centered on the axis of symmetry of each profile or flat bar 11, or off-center (as shown in FIG. 9);
the profiles or flat bars 11 are assembled using an axis 34 and two parts 32 as shown in FIGS. 8 and 9, or with any other pierced tapered shim geometry. Each profile or flat bar 11 is held in place in the oblique slot 36 of a respective part 32A, 32B. The axis 34 passes through the two parts 32A, 32B as well as the two profiles or flat bars 11 via their respective holes 38;
the whole assembly is held in place by means for example of a bolt (not shown), which therefore allows the rotation of the upper part formed by the first part 32A and rigidly connected to a first profile or flat bar 11, relative to the lower part formed by the second part 32B and rigidly connected to a second profile or flat bar 11.

According to a second embodiment shown in FIG. 10, each connector 30 consists of a pivot pin of the bolt or rivet type. According to this second embodiment, the profiles or flat bars 11 of the structure 2 connected by the same connector 30 are arranged such that their extension planes form a substantially perpendicular angle, one of the profiles or flat bars 11 being arranged perpendicularly and transversely to the other. In this case, one of the profiles or flat bars 11 is arranged transversely to the reference surface (surface used for generating pseudo-geodetic lines, and which is not shown in FIG. 10) so that its extension plane forms, with this reference surface, an angle substantially equal to 90 degrees. This profile or flat bar 11 then follows an asymptotic line defined by the alignable mesh 14. The other profile or flat bar 11, arranged such that the angle between its extension plane and the reference surface is zero, for its part follows a geodetic line defined by the alignable mesh 14.

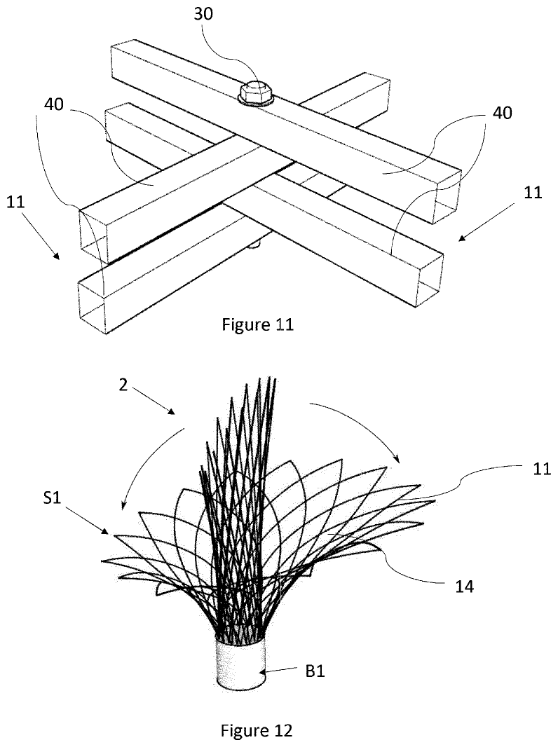

According to a third embodiment shown in FIG. 11, each beam 11 consists of two tubular profiles with rectangular cross section 40, such that the two profiles 40 of a beam 11 that extend in a direction sandwich one of the profiles 40 of the other beam 11 that extends in the other direction. Each connector 30 consists of a pivot pin of the bolt or rivet type. The holes provided in the profiles 40 are optionally eccentric. With a constant eccentricity, the beams 11 thus follow the pseudo-geodetic lines defined by the sides 19 of the alignable mesh 14.

According to another embodiment, not shown in the figures, each connector 30 consists of a pivot pin of the bolt or rivet type, and the profiles or flat bars 11 of the structure 2 connected by the same connector 30 are arranged such that their respective extension planes each form a substantially zero angle with the reference surface. In this case, the two profiles or flat bars 11 follow geodetic lines defined by the alignable mesh 14.

According to another embodiment, not shown in the figures, each connector 30 consists of a pivot pin of the bolt or rivet type, and the profiles or flat bars 11 of the structure 2 connected by the same connector 30 are arranged such that their respective extension planes each form an angle substantially perpendicular to the reference surface. In this case, the two profiles or flat bars 11 follow asymptotic lines defined by the alignable mesh 14.

According to an alternative embodiment not shown in the figures, each joining connector 30 is a connector joining two beams 11 and allowing rotation between these two beams according to three degrees of freedom. Each connector 30 is for example formed by an axis and two tapered shims, the two tapered shim being positioned between the beams and being crossed by the axis. Each tapered shim supports one of the beams and is configured to be able to rotate relative to this beam (unlike the tapered shims 32A, 32B of FIG. 9, which are each secured to a beam 11, and which therefore only allow a single degree of rotational freedom between these beams 11).

According to one possible embodiment of the invention, the method comprises a final step 28 during which, from the almost-linear preform shown in FIGS. 12 and 14, the mesh is deformed so as to obtain a flared final shape corresponding to the deployed second configuration of the structure 2, such a flared final shape being shown for example in FIGS. 12 to 15. The flared final shape is for example a corolla shape. Such a structure 2 with a corolla shape may for example be integrated within a group of three-dimensional-type structures, manufactured or not via the method according to the invention. The three-dimensional structures are then interconnected, preferably in their areas of larger span.

This final shape, which widens from the base B1 toward the upper part S1 of the structure 2, is for example obtained by means of several tie-rods (not shown) connecting the upper edge of the upper part S1 to the floor. Alternatively, in the preferred embodiment according to which the mesh 14 obtained at the end of the first generating step 20 is an alignable mesh consisting of sides 19 that follow pseudo-geodetic lines, the final shape is obtained by self-deployment of the structure 2.

Such tie-rods may for example comprise metal cables, attached to the floor by hooks (not shown). Once the desired flared final shape has been conferred to the mesh, shown in FIGS. 12 to 15, this shape is fixed by placing straps, spacers and/or cables attached to the beams 11 of the structure 2 without the possibility of sliding (such straps, spacers or cables not being shown). An elastic gridshell, as defined above, is thus obtained. Once these straps and/or these spacers and/or these cables have been attached to the structure 2, this structure can retain its flared shape shown in FIGS. 12 to 15, without it being necessary to connect it to an exterior support.

It will be noted that another possible approach, making it possible to dispense with the installation of tie-rods, is to mount the structure 2 according to the invention upside down, that is, with its flared part S1 placed on the floor. Once the straps and/or spacers and/or cables have been placed, the structure 2 is then turned over so as to bring it into its final position, as shown in FIGS. 12 and 14, that is, with the flared part S1 located upward.

As can be understood in view of the above description, the manufacturing method according to the invention allows a compact elastic gridshell structure to be obtained simply which has a high structural strength combined with ease of deployment and transport. It further allows any new geometric shapes to be achieved for the structure, not yet obtained via the manufacturing methods of the prior art. Such geometric shapes rely on obtaining discretized, so-called alignable meshes, which form irregular grids and are generated at the end of the first step of the method.

A very large variety of new shapes can be obtained for the elastic gridshell structure. (Non-limiting) examples of such new shapes are shown in FIGS. 12 to 16.

By comparison with the generation of Chebyshev-type meshes, for which a side constraint is imposed, the generation of such alignable meshes imposes a quadrangle constraint. Now, a discretized quadrangle mesh has approximately two times more sides than quadrangles. Thus, the “alignable” nature of a mesh corresponds to two times fewer constraints than for a Chebyshev mesh, for the generation of the mesh. The manufacture of elastic gridshell structures from such discretized alignable meshes consequently offers a much greater design freedom, compared to the manufacture of such structures from Chebyshev meshes. The alignable meshes therefore confer greater freedom to be able to adjust the shape of an elastic gridshell. This adjustment capacity can for example be used to optimize the shape of the gridshell in order to improve the mechanical performance thereof, or else to reduce the permanent curvature of the beams (which in particular allows the use of thicker, and therefore stronger, beam sections), or else for the purpose of planarizing any cover panels attached to the joining connectors (which facilitates the manufacture thereof).

For purely indicative and non-limiting purposes, an elastic gridshell structure obtained via the method according to the invention can measure between one meter and around ten meters, or even several tens of meters, from above.

The elastic gridshell structure according to the invention may in particular find applications in the fields of construction, urban furniture or urban architecture, space, defense, underwater vehicles, events, or shows and entertainment.

1. A method for manufacturing a three-dimensional structure (2), said three-dimensional structure (2) being deployable in a compact first configuration and at least one deployed second configuration, the method of manufacture comprising:
a first step (20), implemented by computer (4), of generating a mesh (14), the mesh (14) comprising a plurality of discretized quadrangles (16), and a predetermined number of nodes (18) connected to one another by oriented sides (19), a predetermined orientation being assigned to each side (19) among two possible orientations, each elementary quadrangle (16) of the mesh having a first pair of opposite sides (19a) oriented according to a first orientation (S1), and a second pair of opposite sides (19b) oriented according to a second orientation (S2), distinct from the first orientation (S1);
a second step (26) of manufacturing the three-dimensional structure (2), the three-dimensional structure (2) being manufactured from the mesh (14) generated at the end of the first step (20); the three-dimensional structure (2) being in its compact first configuration in the form of a preform, said preform comprising elastically deformable beams (11);
characterized in that the mesh (14) generated during the first step (20) is a so-called alignable mesh, a discretized quadrangle mesh being said to be alignable if such a mesh can be deformed into a rectilinear configuration by angularly modifying the mesh at its nodes (18) and keeping the side (19) lengths constant, or if, for any oriented path traveled along a closed loop (BF1) and composed of oriented path segments (e₁, . . . , eₙ), where each segment coincides with a side (19) of the mesh, the following equation is verified for this path:
$${\sum }_{i = 1}^{n} {ε}_{i} ‖ {e}_{i} ‖ = 0 ;$$
with: εᵢ=+1 if the segment e; has the same orientation as the coincident side of the mesh, and εᵢ=−1 otherwise; ∥eᵢ∥ being the length of the segment eᵢ;
and in that the nodes (18) of the alignable mesh (14) define positions for connectors (30) that join together the beams (11) of the preform, said connectors (30) allowing the beams (11) to be joined together during the step (26) of manufacturing the structure (2), the preform being in its almost-linear compact configuration, in the form of a bundle, and being such that for each of its beams (11), the distance between two adjacent connectors (30) on the beam (11) is not necessarily constant.

2. The method according to claim 1, characterized in that the alignable mesh (14) is generated from an initial discretized quadrangle mesh (12), the alignable mesh (14) being obtained by deformation of the quadrangles (16) of the initial discretized quadrangle mesh (12), and in that the first generating step (20) consists of a digital optimization method based on iterative projections on said initial discretized quadrangle mesh (12), one of said projections being carried out quadrangle (16) after quadrangle (16) by means of a projection operator able to deform any quadrangle (16) into a so-called alignable quadrangle, a quadrangle (16) being said to be alignable if, for an oriented path traveled along a closed loop coinciding with the sides (19) of the quadrangle (16), said equation is verified.

3. The method according to claim 2, characterized in that, during the first generating step (20), one of the iterative projections is carried out on the initial discretized quadrangle mesh (12) by further means of an additional projection operator, said additional operator being able to deform any discretized quadrangle mesh so that the sides (19) of the mesh correspond to pseudo-geodetic lines (22), a pseudo-geodetic line being defined as a line on a reference surface whose angle between the osculating plane and the normal to the surface is identical at each point, the mesh obtained at the end of the first generating step being an alignable mesh (14) consisting of sides (19) that follow almost-geodetic lines (22), the beams (11) of the three-dimensional structure (2) being profiles or flat bars arranged, during the second step (26), so as to follow the pseudo-geodetic lines (22) defined by the alignable mesh (14).

4. The method according to claim 1, characterized in that the alignable mesh (14) is generated from an initial discretized quadrangle mesh (12), the alignable mesh (14) being obtained by deformation of the quadrangles (16) of the initial discretized quadrangle mesh (12), and in that the first generating step (20) comprises a phase consisting of an algorithmic minimization method of a function having several variables and several terms, the variables of said function being the geometry of the initial discretized quadrangle mesh (12), one of the terms of the function being an energy representative of the alignable nature of the mesh, for example an energy defined as follows:
$${E}_{alignable} = {\sum }_{quadrangles} {( {P}_{i , j} {P}_{i + 1 , j} + {P}_{i + 1 , j} {P}_{i + 1 , j + 1} - {P}_{i , j} {P}_{i , j + 1} - {P}_{i , j + 1} {P}_{i + 1 , j + 1} )}^{2} ;$$
the nodes of the mesh being indexed {P_{i,j}, (i, j)∈I, I⊂Z²}, the minimum of said energy being reached if the mesh is alignable, each of the other terms of the function being representative of desired geometric or mechanical properties for the three-dimensional structure (2).

5. The method according to claim 2, characterized in that the initial discretized quadrangle mesh (12) is a rotational-symmetric mesh or a Chebyshev mesh, in particular of the Chebyshev plane mesh type.

6. The method according to claim 1, characterized in that the first step (20) of generating an alignable mesh (14) comprises a first phase consisting in defining a first pseudo-geodetic line on a surface of revolution, a pseudo-geodetic line being defined as a line on a reference surface whose angle between the osculating plane and the normal to the surface is identical at each point; a second phase consisting in duplicating the first pseudo-geodetic line by rotation about the axis of revolution of the surface of revolution, thus providing a first set of pseudo-geodetic lines, and a third phase consisting in symmetrizing the pseudo-geodetic lines obtained during the second phase with respect to a plane containing said axis of revolution, providing a second set of pseudo-geodetic lines, the first and second sets of pseudo-geodetic lines constituting the alignable mesh.

7. The method according to claim 1, characterized in that it further comprises, before the second step (26), an intermediate step (24), implemented by computer (4), comprising a first phase (24a) of modeling additional elements such as braces, spacers or additional cables present on the structure (2), and a second phase (24b) of releasing one or more constraints on the geometry of the alignable mesh (14), in order to obtain a mesh geometry allowing structural equilibrium to be achieved taking into account said additional elements, this intermediate step (24) being carried out following or in parallel with the first step (20).

8. The method according to claim 7, characterized in that the second phase (24b) of releasing one or more constraints on the geometry of the alignable mesh (14) comprises implementing a mechanical model of the beams, in particular a model of projective dynamics, dynamic relaxation or finite elements of the mechanics of the beams such as, for example, a model taking into account the axial behavior, the torsion and the biaxial bending, and/or implementing a model to impose position constraints on the edges.

9. A computer program product (10) that can be downloaded from a communication network and/or recorded on a computer-readable medium (4) and/or executed by a processor (7), characterized in that it comprises program instructions, said program instructions implementing at least the step (20) of generating the alignable mesh (14) of the method according to claim 1 when said instructions are executed on a processing unit (6) of a computing device (4).

10. A three-dimensional structure (2) deployable between a compact first configuration and a deployed second configuration, the three-dimensional structure (2) comprising elastically deformable beams (11) joined together by connectors (30), characterized in that the three-dimensional structure (2) is manufactured via the method according to claim 1.

11. The three-dimensional structure (2) according to claim 10, characterized in that the structure forms an element from the group consisting of: an urban furniture element or an urban architecture element, a satellite module or a spacecraft, a submarine module, a support, a temporary or non-temporary shelter, a show and/or entertainment decorative element, a toy, a reinforced concrete shell reinforcement, and a permanent or temporary concrete shell formwork.

12. The three-dimensional structure (2) according to claim 10 when the structure (2) is characterized in that each joining connector (30) within the structure (2) is a connector joining two beams (11) and allowing rotation between these two beams (11) according to a single degree of freedom.

13. The three-dimensional structure (2) according to claim 10, characterized in that each joining connector (30) within the structure (2) is made up of two parts (32, 32A, 32B) pivotally mounted relative to one another about a common axis (34), the two parts (32, 32A, 32B) being arranged on one another and being crossed by the axis (34), each part (32, 32A, 32B) being configured to receive and hold a beam (11), for example by means of an oblique receiving and holding slot (36) provided in the part (32, 32A, 32B), each part (32, 32A, 32B) assuming a pierced tapered shim geometry.

14. The three-dimensional structure (2) according to claim 10, characterized in that each joining connector (30) within the structure (2) is a connector joining two beams (11) and allowing a rotation between these two beams (11) according to three degrees of freedom, each connector being formed by an axis and two tapered shims, the two tapered shims being positioned between the beams and being crossed by the axis, each tapered shim supporting one of the beams and being configured to be able to rotate relative to said beam.

15. A group of interconnected three-dimensional structures, characterized in that at least one of the three-dimensional structures (2) is according to claim 10, the structures preferably being interconnected in their area of larger span.
